(19) United States
(12) Patent Application Publication
(10) Pub. No.: US 2025/0030999 A1
(43) Pub. Date: Jan. 23, 2025

(54) EDITOR AND PLAYER IN EIGHT REAL DIMENSIONS

(71) Applicant: Luis VILA VILA, Barcelona (ES)

(72) Inventor: Luis VILA VILA, Barcelona (ES)

(21) Appl. No.: 18/710,842

(22) PCT Filed: Jan. 16, 2023
(86) PCT No.: PCT/ES2023/000001

§ 371 Date: May 16, 2024

(30) Foreign Application Priority Data
Nov. 16, 2021 (ES) P202100118

(51) Int. Cl. H04S 3/00; H04S 7/00

(52) U.S. Cl. CPC H04S 3/00; H04S 7/00

(57) ABSTRACT

The invention relates to an editor and player in eight real dimensions, characterised by a software and hardware suite that allows music to be recorded and mixed in eight different channels to create the sensation of immersive sound, so that the music feels as real for the listener as if it were being performed live around them. The suite consists of a sound manipulation software program and a distribution device capable of recording, editing and mixing multi-channel music pieces combined with reverberation effects and directivity and directionality patterns.

### SUMMARY

The invention relates to an editor and player in eight real dimensions, characterized by a software and hardware suite that allows music to be recorded and mixed in eight different channels to create the sensation of immersive sound, so that the music feels as real for the listener as if it were being performed live around them. The suite consists of a sound manipulation software program and a distribution device capable of recording, editing and mixing multi-channel music pieces combined with reverberation effects and directivity and directionality patterns.

### TECHNICAL SECTOR

The invention presented affects the Physics Sector (G) in its MUSICAL INSTRUMENTS section; ACOUSTICS (G10), subsection O (G10H) ELECTROPHONE MUSIC INSTRUMENTS; INSTRUMENTS IN WHICH TONES ARE GENERATED BY ELECTROMECHANICAL MEANS OR BY ELECTRONIC GENERATORS, OR IN WHICH SOUNDS ARE SYNTHESIZED FROM A DATA MEMORY, number 1/047: by acoustic-mechanical means, e.g. by rotating speakers or by sound detectors, its classification being G10H 1/047.

### BACKGROUND OF THE INVENTION

Nowadays, music is becoming a growing economic sector in the market. The consumption of music tracks in eight dimensions has become widespread among passionate music lovers, who discover in their commitment to listening to music in eight dimensions a feasible illusion of a sound perceived in 360 degrees from their position as a receiver of musical waves in constant movement. This perception consists of a three-dimensional sound, to which special effects and mixes are applied that create the sensation that the music moves around the listener using eight dimensions when actually three are being used.

This is achieved through a three-dimensional simulator with stereo sound. The software manipulates the audio to trick the brain's sensory perception into believing that the music has movement and revolves around the individual.

In reality, eight-dimensional music creators use software that can manipulate the different stereo parts of a song, placing and moving them in a virtual 360-degree space. The listener, in this case, only needs headphones to be able to live the sound experience. However, without them, the effect is less effective.

While the results of this technology are surprising, it is still limited to a simulation. To get closer to true eight-dimensional listening, track mixes with variations on a minimum of eight channels are necessary. Something like a score written with eight simultaneous staves, each one made to generate a sound position whose combination will generate the sensation of hearing and feeling a live orchestra within a perfect acoustic dome.

This means that the sound is distributed evenly in space, maintaining the same sound intensity, with an essential characteristic and that is that the mixing of the tracks ensures that the sound that reaches the listener's left ear is different from the one that reaches his or her right ear, even allowing you to determine the direction of production of said sound (up, down, front, back, etc.)

The work is so complex that it cannot be carried out by a user without knowledge of musical technique.

The time invested, as well as advanced knowledge in musical architecture and programming, increases costs and diminishes the possibility of creating and marketing this type of tracks.

Because of this, there are currently no real new recordings with eight-dimensional mixes of pre-existing songs and/or musical performances.

The eight-dimensional player and editor object of the invention is intelligent software that allows the recording of these eight independent channels, applying the effects to each one separately, and which will then generate a mix that supplies eight channels programmed to be distributed in a precisely shaped multi-room that generates the desired effect.

The application of this music player and editor provides real sound in eight dimensions with unmatched sound clarity and a surround effect that changes the location of the receiver-listener from being alone in front of the sound to being in the middle, and therefore surrounded by sound waves. This method is more precise than a simulation since it refers to real sound and the technique is within the reach of any music production professional or advanced amateur.

The applicant is unaware of the existence of methods or simulators for purchase in establishments with the characteristics of this Invention.

### EXPLANATION OF THE INVENTION

The present invention refers to an electronic tool intended for people who are professionally or amateurly dedicated to music production.

The editor and player in eight real dimensions is a set of software and hardware that allows the recording and mixing of music in eight different channels to give the sensation of immersive sound, so that the listener feels the music as real as if it were being produced live and around you. A new way of listening to music that changes the perspective of the receiver, from perceiving the sound as the audience to finding themselves in the same orchestra or musical wave station.

The advance object of this invention results from a mixture of programming with musical production to reach a new level of sensitive virtualization of sound.

Its scope is not limited only to music. It can also be applied in medicine and in the field of auditory stimulation and rehabilitation.

The real eight-dimensional editor and player is composed of a sound manipulation program and a distribution team.

The program is an intelligent sound positional computing application, capable of recording, editing and mixing multi-channel musical pieces combined with reverb effects and directivity and directionality patterns.

It has a novel program aimed at providing high spatial fidelity audio with improved modifications of the Ambisonics system and a three-dimensional extension of the M/S (middle/side) stereo, adding additional difference channels for height and depth.

It also includes a sound production based on the Haas effect, that is, very short delay times to create amplitude, and longer delays to give a greater sense of directionality.

The human ear focuses on intensity and time to perceive sound, so using the Haas effect generates a feeling of realism and far exceeds the stereo effect.

Currently on the market there are various plugins and programs that allow you to emulate sound in eight dimensions through the editing of a single track to which effects are applied. One of the most popular is Resonance Audio.

However, all of them work on arrangements with a single track entered by the user and a maximum of four sound directions. In addition, they force the user to use headphones to enjoy music, thus limiting their perceptive ability.

With a modification in the algorithms and programming lines, the software object of invention manages to input different tracks through different channels, intelligently adding amplitude, depth and directionality effects to each of them.

The software has pan potentiometers that adjust the volume going to each channel, and a delay function that controls the time of each channel.

Additionally, this innovative technique adds the up and down positions of each direction (front, back, right, left) generating a real eight-position sound, a sound in eight dimensions and not an emulation.

Once the generation of the musical tracks has been resolved, the software is prepared to output the sound of the tracks independently through a PC with four multichannel sound cards synchronized to a 5.1 speaker system with multichannel technology known as multi room.

It is an output system based on the connection capacity of some wireless speakers and independently controlled through the program. This way, each speaker will have a different location and transmit two channels.

While 5.1 is the common name for multichannel audio systems with six channels of sound, in this invention, some small output modifications are made to guarantee quality surround sound while maintaining an ideal distribution of eight speakers, although it could be generated in a minimum of five speakers, with the traditional channels (a left and right front part, a center channel, two surround sound channels and a subwoofer), increasing two simultaneous channels that will add the depth and movement of the sound is undoubtedly a fundamental part of the success of music reproduction.

This system allows each speaker to emit different perfectly synchronized tracks that the brain will join together into a single piece of music, the same effect of an orchestra in motion around the listener.

The result is an immersion of the listener in a virtual dome where the sound has movement that is clearly differentiated.

Described so far, the production of these musical tracks would generate a new challenge for musicians. We are talking about a composition for eight channels that would include, in addition to harmony, directionality and depth.

This is a process that can be long and tedious for an average or common user. For this reason, we have integrated into the software an open-source artificial intelligence complement whose learning level allows us to understand the user's preferences and adapt the algorithms automatically.

Thus, the automation of the composition process reduces the costs and time of each musical project without reducing its quality.

Since the predictive capacity and the automation process are experimental functions that require constant learning, an open source will be kept to allow more advanced users to implement new utilities.

### BRIEF DESCRIPTION OF THE DRAWINGS

To complement the description that is being made and in order to help a better understanding of the characteristics of the invention, a set of drawings is attached as an integral part of said description, where, with an illustrative and non-limiting nature, the following has been represented:

FIG. 1.—Shows a plan view of the eight speakers and the receiver. The following elements are distinguished:
1. Speaker 1-Channel 1.
2. Speaker 2-Channel 2.
3. Speaker 3-Channel 3.
4. Speaker 4-Channel 4.
5. Speaker 5-Channel 5.
6. Speaker 6-Channel 6.
7. Speaker 7-Channel 7.
8. Speaker 8-Channel 8.

FIG. 2.—Shows a view of the software tracing the directionality of sound in a virtual room. The subject is graphed as a cube and the movement of the camera traces the path that the audio output must take.

FIG. 3.—Shows a front view of the sound envelope that gives rise to the invention.

### PREFERRED EMBODIMENT OF THE INVENTION

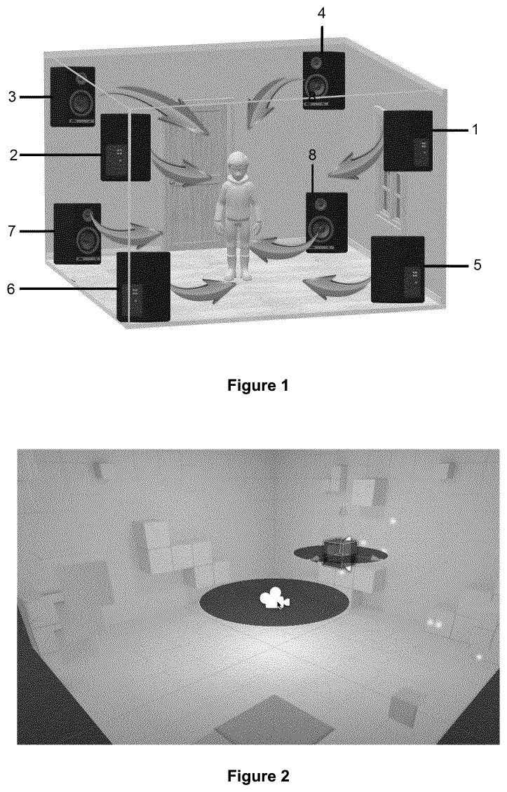

The real eight-dimensional music editor and player consists of a simulation of a three-dimensional subject (FIG. 2), represented by a cube or another geometric figure, that will identify the position of the user (listener). By applying computer algorithms, it will trace sound movement instructions around said subject in eight channels: left, up, front (channel 1); right, up, front (channel 2); right, up, behind (channel 3): left, up, behind (channel 4); left, down, front (channel 5); right, down, front (channel 6); right, down, behind (channel 7); left, down, behind (channel 8).

These channels will combine movements in six positions: above, below, in front, behind, left and right.

These movements will take into account the distance from the emission point (speaker) to the receiving subject (FIG. 1) and will intelligently adjust to the reception differences of a human ear. That is, the direction from which a sound arrives is recognized by two facts. On the one hand, because the sound reaches the ear closest to the sound source first. For example, if a noise is perceived behind and to the left, the left ear will capture the sound signal a few milliseconds before the right. And on the other hand, because the sound reaches with more intensity the ear closest to the emitting source. The software, through a dynamic algorithm, introduces variations to the sound so that the receiver's brain recognizes it from different emission points.

The algorithms will vary the intensity, depth and speed, in eight different ways coupled to the needs of each position described. Although the process has a degree of automation, it allows the user to adjust these settings.

In each of these outputs, the user will enter a track with the corresponding modifications. The program allows the user to generate the desired tempos and effects for each track. It will also specify the mix and intensity of each output channel to generate the effects of a live sound. A preview will sync the tracks and allow the user to see the output trajectory of each channel and check height and depth. Dynamic programming allows different variables to be stored in order to automate and speed up the application of effects. The modified tracks will be distributed on four sound cards with two outputs each. With the previously programmed instructions, the software will distribute the tracks corresponding to each output and finally give the playback order.

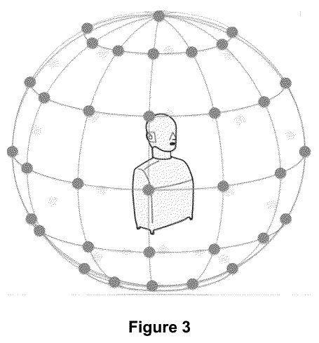

Each speaker will receive its own audio channel and will generate sound routing according to previously programmed instructions. The combination of the eight outputs will surround the listener, simulating a perfect acoustic dome that will surround the subject (FIG. 3) and transport them to the center of the sound emission.

It should be noted that, although the sound has a previously programmed routing, it will not be static. It will have movement effects that will make the listener have the sensation that the sound is moving around them. This will contribute to the elimination of external noise from the playback and will combat the acoustic problems of some places, since it does not need rebound walls.

However, it must be understood that the invention has been described according to a preferred embodiment, so it may be susceptible to modifications without this entailing any alteration of the basis of said invention; That is to say, the terms in which this preferred description of the invention has been stated must always be taken with a broad and non-limiting nature.

1. Apparatus and Method for recording, editing and reproducing sound in eight dimensions that includes the following stages:
Stage 1: audio input using monophonic or polyphonic tracks.
Stage 2: one or more data entries. These entries are associated with a weighting factor called distance. In addition, they determine the conditions of sound production, such as distance, obstacles, heights, etc.
Stage 3: virtualization of space. Here the characteristics of the space where the sound will be reproduced and the movement or behavior expected of it are physically defined.
Stage 4: definition of the subject regarding the sound. It is a body which relates the user's position to the position of obstacles (walls) and combines the results with movement instructions: the up and down positions of each direction (front, behind, right, left) and combines the results following a propagation rule.
Stage 5: application of behavioral algorithms and combination of clues. This is an activation function that is particularly used for multiclass problems, that is, for problems in which the aim is to establish a classification with more than two possible classes or categories. This function, given a vector of real values, gives each data proportional values in the interval [0, 1], in such a way that the sum of the vector values is 1. Applied to the last layer of an Artificial Neural Network multiclass, which has as many nodes as there are classes in the problem, it normalizes the values by establishing a probabilistic distribution. In this case, the functions are based on the Haas effect that will allow the different tracks to be combined to verify their correct synchronization.
Stage 6: sound preview. A graphic that reproduces the modifications of the previously created tracks and allows the user to make any manual modifications that they consider necessary.
Stage 7: export of the sound. There will be eight audio tracks distributed through the sound card to eight speakers. Each track will have its own instructions on how to act, the speed and the order in which it should be played.
The set of software and hardware carries out the simulation of a three-dimensional subject (represented by a cube or another geometric figure) that will identify the position of the user (listener). By applying computer algorithms, it will trace sound movement instructions around said subject in eight channels: left, up, front (channel 1); right, up, front (channel 2); right, up, behind (channel 3); left, up, behind (channel 4); left, down, front (channel 5); right, down, front (channel 6); right, down, behind (channel 7); left, down, behind (channel 8).
These channels combine movements in six positions: above, below, front, behind, left and right.
In each of these outputs, the user will enter a track with the corresponding modifications. The program enables the user to generate the desired tempos and effects for each track. Likewise, it will specify the mix and intensity of each output channel to generate the effects of a live sound. A preview will sync the tracks and allow the user to see the output trajectory of each channel and check height and depth.
Dynamic programming stores different variables in order to automate and speed up the application of effects. The modified tracks will be distributed on four sound cards with two outputs each. With the previously programmed instructions, the software will distribute the tracks corresponding to each output and finally give the playback order.
Each speaker will receive its own audio channel and will generate sound routing according to previously programmed instructions. The combination of the eight outputs will surround the listener, simulating a perfect acoustic dome that will surround the subject and transport them to the center of the sound emission.

2. Device and Method for recording, editing and reproducing sound in eight dimensions, which converts monophonic tracks into binaural sounds through neural algorithms of Artificial Intelligence. The basic principle is that these algorithms are automated so that they introduce both the recording variables (as is the case with the Ambisonics system) and the audio playback variables, achieving a natural, more precise and more real sound. This is characterized by the following:
a-. Processor (corei 7, as a minimum), RAM memory (more than 32 GB), Hard drive (more than 500 GB), Bluetooth peripherals and audio outputs, sound card with preamplification and eight audio outputs, configured previously for sound distribution in 8 amplifiers or multiples thereof.
b-. Eight self-powered speakers
c-. One or more data inputs that generate the sound production conditions, such as distance, obstacles, heights, etc.
d-. Virtualization of the space that reproduces the characteristics of the space where the sound will be reproduced and the movement or behavior expected of it.
e-. Definition of the subject with respect to the sound. It is a body which relates the position of the user with the position of the obstacles (walls) and combines the results with the movement instructions: the positions up and down in each direction (front, behind, right, left) and combines the results following a propagation rule.
f-Sound preview, a graphic that reproduces the modifications of the tracks created previously and allows the user to make any manual modifications that they consider necessary.
g-. Sound export using eight audio tracks distributed through the sound card to eight speakers.
